(19) United States
(12) Patent Application Publication
(10) Pub. No.: US 2020/0319419 A1
(43) Pub. Date: Oct. 8, 2020

(54) Optical Fiber Cables With Improved Burn And Smoke Performance

(71) Applicant: Superior Essex International LP, Atlanta, GA (US)

(72) Inventors: Paul E. Neveux, JR., Atlanta, GA (US); Gerald Pavlicek, Woodstock, GA (US)

(21) Appl. No.: 16/357,827

(22) Filed: Mar. 19, 2019

Related U.S. Application Data
(60) Provisional application No. 62/648,044, filed on Mar. 26, 2018.

(51) Int. Cl. G02B 6/44

(52) U.S. Cl. CPC G02B 6/4436; G02B 6/4494; G02B 6/443

(57) ABSTRACT

Optical fiber cables having improved smoke and burn performance are described. An optical fiber cable includes an outer jacket defining a cable core, and at least one buffer tube is positioned within the cable core. One or more optical fibers are positioned within a buffer tube, and a tape is wrapped around the one or more optical fibers within the buffer tube. The tape is a low smoke tape having an average optical smoke density equal to or below 0.15 when burned.

### CROSS-REFERENCE TO RELATED APPLICATION

This application claims priority to U.S. Provisional Application No. 62/648,044, filed Mar. 26, 2018 and entitled “Optical Fiber Cables with Improved Burn and Smoke Performance,” the contents of which is incorporated by reference herein in its entirety.

### TECHNICAL FIELD

Embodiments of the disclosure relate generally to optical fiber cables and, more specifically, to optical fiber cables having tapes positioned within one or more buffer tubes in order to improve burn and smoke performance.

### BACKGROUND

Fiber optic cables are utilized in a wide variety of applications to transmit data. Certain types of fiber optic cables are designed to satisfy the requirements of one or more cable standards. For example, cables designed for riser and/or plenum applications must often satisfy applicable burn or fire standards, such as National Recognized Testing Laboratory (“NRTL”) burn standards. In order to satisfy conventional burn standards, typical cable designs often attempt to limit use of materials that contribute as fuel during a burn situation or attempt to limit exposure of flammable materials to a fire.

Many fiber optic cables include optical fibers that are positioned within one or more buffer tubes. In a burn situation, there is often an initial smoke peak when a cable first encounters a fire. There may then be a second smoke peak when the buffer tube is compromised and the fire encounters the optical fibers and, in some cases, ribbon material associated with the optical fibers. The occurrence of the second smoke peak may often cause the cables to fail one or more burn requirements, such as an average optical smoke density requirement. Accordingly, there is an opportunity for optical fiber cables with improved burn and smoke performance. In particular, there is an opportunity for improved optical fiber cables having one or more relatively low smoke tapes positioned within optical fiber buffer tubes.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items; however, various embodiments may utilize elements and/or components other than those illustrated in the figures. Additionally, the drawings are provided to illustrate example embodiments described herein and are not intended to limit the scope of the disclosure.

FIG. 1 is a cross-sectional view of an example optical fiber cable that incorporates one or more low smoke tapes into a buffer tube, according to an illustrative embodiment of the disclosure.

FIG. 2 is a cross-sectional view of an example optical fiber cable that includes a plurality of buffer tubes that incorporate one or more low smoke tapes, according to an illustrative embodiment of the disclosure.

### DETAILED DESCRIPTION

Various embodiments of the present disclosure are directed to fiber optic cables having improved smoke and/or burn performance. In certain embodiments, a fiber optic cable may include at least one buffer tube, and one or more optical fibers may be positioned within the buffer tube. Additionally, at least one tape may be wrapped around the one or more optical fibers within the buffer tube. According to an aspect of the disclosure, the tape may have a low optical smoke density when burned, such as an average optical smoke density equal to or below approximately 0.15 and/or a peak optical smoke density equal to or below approximately 0.50. When the cable is subjected to a burn situation and the buffer tube is compromised, the tape may reduce smoke and/or enhance flame retardancy relative to conventional cables. As a result, the cable may exhibit improved performance when subjected to premises cable burn testing. A jacket may then be formed around the at least one buffer tube and/or any other internal cable components.

In certain embodiments, a single low smoke tape may be incorporated into a buffer tube. In other embodiments, a plurality of tapes may be incorporated into a buffer tube. Additionally, a tape may be longitudinally wrapped around or curled around the one or more optical fibers, thereby encapsulating or encircling the optical fibers along a longitudinal direction. As desired, a tape may be wrapped around the optical fibers with any suitable degree of overlap as the longitudinally extending widthwise edged of the tape are wrapped. In other embodiments, a tape may be helically wrapped around the optical fibers, and the tape may overlap itself at each adjacent helical wrapping.

A wide variety of suitable tapes may be utilized as desired in various embodiments. For example, in certain embodiments, spun bond glass tape, woven glass tape, or other suitable glass tape may be utilized. In other embodiments, a mica tape, low smoke zero halogen (“LSZH”) tape, or other suitable tape having low smoke density or low smoke output when burned may be utilized. Each tape incorporated into a buffer tube may be formed from a wide variety of suitable materials and/or with a wide variety of suitable dimensions, such as any suitable widths and/or thicknesses. Additionally, each tape may be formed with any number of suitable layers. Any number of suitable additives and/or coatings may also be incorporated into and/or formed onto a tape, such as flame retardant and/or smoke suppressing additives and/or coatings. In certain embodiments having multiple tapes, each tape may have a similar construction. In other embodiments, at least two tapes may be formed from different materials and/or with different dimensions.

As desired in various embodiments, one or more additional layers may be incorporated into a cable. For example, one or more strength members (e.g., aramid yarns, etc.) and/or water blocking materials may be incorporated into a buffer tube. In certain embodiments, an additional layer (e.g., strength layer, water blocking layer, etc.) may be positioned between the low smoke tape(s) and the optical fibers. As another example, one or more strength members and/or water blocking materials may be positioned between the buffer tube and the cable jacket. Indeed, a wide variety of suitable cable constructions may be formed with any number of suitable components.

Certain example embodiments of the disclosure now will be described more fully hereinafter with reference to the accompanying drawings, in which certain embodiments of the disclosure are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

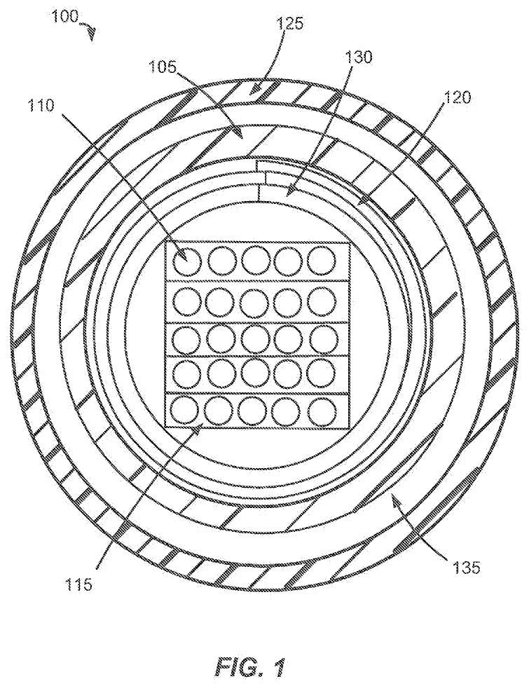

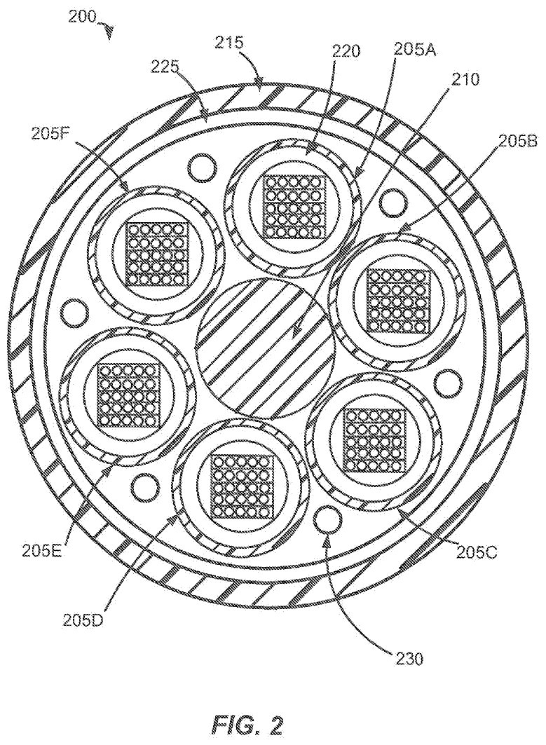

FIGS. 1 and 2 illustrate cross-sectional views of example cable constructions that incorporate one or more low smoke tapes into optical fiber buffer tubes. The described cables are provided by way of non-limiting example only, and it will be appreciated that a wide variety of other suitable cable constructions may be formed in addition to those described. Embodiments of the disclosure may also be utilized in conjunction with a wide variety of suitable cables including, but not limited to, premises cables, horizontal cables, vertical cables, plenum cables, riser cables, data center cables, hybrid cables, and/or any other appropriate cables.

Turning now to FIG. 1, a cross-sectional view of a first example optical fiber cable 100 is illustrated. The illustrated cable 100 may include a single buffer tube 105 with one or more optical fibers 110 positioned within the buffer tube 105, such as the depicted plurality of optical fibers 110 that are incorporated into a ribbon stack 115. Additionally, at least one low smoke tape 120 may be positioned within the buffer tube 105 and wrapped around the optical fibers 110. A jacket 125 may then be formed around the buffer tube 105 and/or any other internal cable components. When the cable 100 is subjected to a burn situation and the buffer tube 105 is compromised or penetrated by the burn, the tape 120 may reduce smoke and/or enhance flame retardancy relative to conventional cables. As a result, the cable 100 may exhibit improved performance relative to conventional cables when subjected to premises cable burn testing.

As desired in various embodiments, a wide variety of other components may additionally be incorporated into the cable 100. For example, one or more suitable inner wraps 130 or other components may be incorporated into a buffer tube 105 between the optical fibers 110 and the low smoke tape 120. Examples of suitable inner wraps 130 include, but are not limited to, water blocking layers, strength layers (e.g., strength yarns, etc.), and/or similar components. As another example, one or more suitable outer wraps 135 or other components may be positioned between the buffer tube 105 and the outer jacket 125. Examples of suitable outer wraps 135 include, but are not limited to, water blocking layers, strength layers, and/or similar components. Each of the components of the cable 100 illustrated in FIG. 1 are described in greater detail below.

The outer jacket 125 may define an outer periphery of the cable 100. The jacket 125 may enclose the internal components of the cable 100, seal the cable 100 from the environment, and provide strength and structural support. The jacket 125 may be formed from a wide variety of suitable materials, such as a polymeric material, polyvinyl chloride (“PVC”), polyurethane, one or more polymers, a fluoropolymer, polyethylene, medium density polyethylene (“MDPE”), neoprene, chlorosulfonated polyethylene, polyvinylidene fluoride (“PVDF”), polypropylene, modified ethylene-chlorotrifluoroethylene, fluorinated ethylene propylene (“FEP”), ultraviolet resistant PVC, flame retardant PVC, low temperature oil resistant PVC, polyolefin, flame retardant polyurethane, flexible PVC, low smoke zero halogen (“LSZH”) material, plastic, rubber, acrylic, or some other appropriate material known in the art, or a combination of suitable materials. As desired, the jacket 125 may also include flame retardant materials, smoke suppressant materials, carbon black or other suitable material for protection against exposure to ultraviolet (“UV”) light, and/or other suitable additives. The jacket 125 may include a single layer or, alternatively, multiple layers of material (i.e., multiple layers of the same material, multiple layers of different materials, etc.). As desired, the jacket 125 may be characterized as an outer sheath, a casing, a circumferential cover, or a shell.

The jacket 125 may enclose one or more openings in which other components of the cable 100 are disposed. At least one opening enclosed by the jacket 125 may be referred to as a cable core, and any number of other cable components may be disposed in a cable core. In the cable 100 illustrated in FIG. 1, the buffer tube 105 and one or more optional outer wraps 135 may be situated within a cable core. A wide variety of other components may be situated within a cable core as desired, such as other buffer tubes, other transmission media, tight buffered optical fibers, various separators or dividers, spacers, inner jackets, etc. Indeed, a wide variety of different cable constructions may be utilized in accordance with various embodiments of the disclosure.

Additionally, the illustrated cable 100 has a circular or approximately circular cross-sectional profile. In other embodiments, other cross-sectional profiles (e.g., an elliptical or oval profile, etc.) and/or dimensions may be utilized as desired. In other words, the jacket 125 may be formed to result in any desired shape. The jacket 125 may also have a wide variety of dimensions, such as any suitable or desirable outer diameter and/or any suitable or desirable wall thickness. Additionally, in certain embodiments, the cable profile may be formed to facilitate a specific function and/or to facilitate installation of the cable. For example, a cable profile may facilitate duct or conduit installation, and the cable 100 may be designed to withstand a specified installation tensile loading and/or other suitable design parameters. In certain embodiments, at least one “ripcord” may be incorporated into the cable 100, for example, within a cable core. A ripcord may facilitate separating the jacket 125 from other components of the cable 100. In other words, the ripcord may help open the cable 100 for installation or field service. A technician may pull the ripcord during installation in order to access internal components of the cable 100.

In certain embodiments, one or more strength members may be embedded in the jacket 125. For example, the jacket 125 may be formed or extruded around one or more strength members. Embedded strength members may be located at any desired points within the jacket 125. For example, strength members may be located on opposing lateral sides of a longitudinal axis of the cable 100. The strength members may enhance tensile strength of the cable 100. In other embodiments, one or more strength members may be situated within a cable core. Indeed, a wide variety of strength member configurations may be utilized. As desired, any number of strength members, an armor layer, and/or other materials may also be incorporated into the cable 100.

The buffer tube 105 may be a suitable sheath configured to house one or more optical fibers, such as a plurality of optical fibers 110 arranged in a ribbon stack 115 or in one or more ribbons. The buffer tube 105 may be formed from any suitable materials or combinations of materials. Examples of suitable materials include, but are not limited to, various polymers or polymeric materials, acrylate or acrylics (e.g., acrylic elastomers, etc.), polyvinyl chloride (“PVC”), polyurethane, a fluoropolymer, polyethylene, neoprene, polyvinylidene fluoride (“PVDF”), polybutylene terephthalate (“PBT”), ethylene, plastic, or other appropriate materials or combinations of suitable materials. Additionally, the buffer tube 105 may be formed as either a single layer or a multiple layer buffer tube. In the event that multiple layers are utilized, the layers may all be formed from the same material(s) or, alternatively, at least two layers may be formed from different materials or combinations of materials. For example, at least two layers may be formed from different polymeric resins. As another example, a flame retarding or other suitable additive may be incorporated into a first layer but not into a second layer. Further, the buffer tube 105 may have any suitable inner and/or outer diameters as desired in various applications. For example, the buffer tube 105 may be appropriately sized to house the optical fibers 110, the tape 120, and/or any other components incorporated into the buffer tube 105 (e.g., an inner wrap 130, etc.).

In certain embodiments, the buffer tube 105 may be formed as a loose tube. In other words, the optical fibers 110 may be loosely positioned within the buffer tube 105. As desired, a plurality of optical fibers 110 may be arranged into one or more suitable bundles or groupings. In other embodiments, a plurality of optical fibers may be incorporated into one or more ribbons and/or a ribbon stack. In yet other embodiments, the buffer tube 105 may be formed as a microtube. A microtube may have an inner diameter that is sized to allow the optical fibers to move relative to one another while preventing the optical fibers from crossing over or overlapping one another. In other words, the microtube may permit the optical fibers to flex or move as the cable is flexed or bent while simultaneously maintaining the position of each optical fiber relative to the other optical fibers. In certain embodiments, an inner diameter of the microtube may be determined based at least in part on the number of optical fibers to be positioned within the microtube, the outer diameters of the optical fibers, and/or the dimensions of the tape 120 and/or other internal components. As a result of using one or more microtubes, it may be possible to reduce or minimize the diameter of the cable 100 relative to cables that incorporate loose buffer tubes. In yet other embodiments, one or more microtubes that house optical fibers may be positioned within a larger buffer tube 105.

With continued reference to FIG. 1, any suitable number of optical fibers 110 may be housed within the buffer tube 105. Each optical fiber may be a single mode fiber, multi-mode fiber, pure-mode fiber, polarization-maintaining fiber, multi-core fiber, or some other optical waveguide that carries data optically. Additionally, each optical fiber may be configured to carry data at any desired wavelength (e.g., 1310 nm, 1550 nm, etc.) and/or at any desired transmission rate or data rate. The optical fibers 110 may also include any suitable composition and/or may be formed from a wide variety of suitable materials capable of forming an optical transmission media, such as glass, a glassy substance, a silica material, a plastic material, or any other suitable material or combination of materials. Each optical fiber may also have any suitable cross-sectional diameter or thickness. In certain embodiments, an optical fiber may include a core that is surrounded by a cladding. Additionally, one or more suitable coatings may surround the cladding.

In certain embodiments, a plurality of optical fibers 110 may be arranged into one or more fiber ribbons and/or into a ribbon stack, such as illustrated ribbon stack 115. For example, optical fibers 110 may be formed or incorporated into a plurality of different ribbon arrangements that are stacked on top of one another to form a ribbon stack 115. As another example, optical fibers 110 may be formed into one or more ribbon arrangements that are folded or otherwise manipulated into a stack or other configuration. As yet another example, optical fibers 110 may be arranged in one or more ribbons that each include intermittent, spaced, or spiderweb-type bonding that permits the ribbons to be bundled, rolled, and/or otherwise formed into a desired arrangement. Regardless of the number and/or types of ribbons utilized in a ribbon stack 115 or other arrangement, each ribbon may include any suitable number of optical fibers that are bonded or otherwise joined together. In certain embodiments, a plurality of ribbons may each include the same number of fibers. For example, a 144 count ribbon stack may be formed from twelve ribbons having twelve fibers each. In other arrangements, at least two ribbons may include different numbers of optical fibers. For example, ribbons may be arranged in a tapered configuration within a ribbon stack 115.

In certain embodiments, when a plurality of optical fibers are arranged into a ribbon stack 115, certain optical fibers may be arranged in accordance with predetermined macrobending (“MAC”) numbers. For example, an optical fiber positioned at a corner of the ribbon stack 115 may have a predetermined MAC number that inhibits optical attenuation of the corner fiber when subjected to compressive forces. In other words, a corner fiber may have a MAC number that results in the fiber being less sensitive to optical attenuation when the cable 100 is subjected to microbending, which can occur if the cable 100 is compressed or if the length of the cable 100 is reduced due to low temperatures.

Additionally, in accordance with an aspect of the disclosure, at least one low smoke tape 120 may be longitudinally wrapped around the optical fiber(s) 110. For example, as shown in FIG. 1, a low smoke tape 120 may be wrapped around the ribbon stack 115 between the ribbon stack 115 and the buffer tube 105. According to an aspect of the disclosure, the tape 120 may be positioned adjacent to an inner surface of the buffer tube 105. Accordingly, in the event that the buffer tube 105 is compromised in a fire or burn event, the tape 120 may reduce the ability of the fire to burn the optical fibers 110 and/or other internal components of the buffer tube 105. Additionally, because the low smoke tape 120 may be formed from materials that do not burn easily, the tape 120 may reduce or limit an amount of smoke emitted in a burn situation when the buffer tube 105 is compromised.

According to an aspect of the disclosure, a low smoke tape 120 may have an average optical smoke density equal to or below approximately 0.15 when the low smoke tape 120 is burned. In certain embodiments, the tape 120 may have an average optical smoke density of approximately 0.15, 0.13, 0.12, 0.10, 0.08, 0.075, 0.06, 0.05, 0.04, 0.03, 0.025, or 0.02, an average optical smoke density included in a range between any two of the above values, or an average optical smoke density included in a range bounded on a maximum end by one of the above values. Additionally, in certain embodiments, a low smoke tape 120 may have a peak optical smoke density equal to or below approximately 0.50 when the low smoke tape 120 is burned. In certain embodiments, the tape 120 may have a peak optical smoke density of approximately 0.50, 0.45, 0.40, 0.35, 0.30, 0.25, 0.20, 0.15, 0.10, 0.05, a peak optical smoke density included in a range between any two of the above values, or a peak optical smoke density included in a range bounded on a maximum end by one of the above values. As explained in greater detail below, the tape 120 may be formed from a wide variety of suitable materials and/or combinations of materials. For example, the tape 120 may be formed from one or more materials that, when exposed to a burn event, limit or eliminate the formation of smoke. Additionally, the tape 120 may be formed with a wide variety of suitable dimensions.

The average and/or peak optical smoke density of the tape 120 may measure the propensity of the tape 120 to generate smoke when exposed to a flame or heat source. In a typical test to measure optical smoke density, the tape 120 may be burned in a suitable chamber for a desired period of time (e.g., approximately 20 minutes, etc.), and a level of light obscuration may be measured within the chamber. For example, a light source may be positioned at one end of the chamber and a photodetector positioned at an opposite end of the chamber may be used to measure how much the light is obscured. As the number of smoke particles in the chamber increases, the measured optical density will be reduced.

In certain embodiments, a single low smoke tape 120 may be wrapped around the optical fibers 110. In other embodiments, a plurality of low smoke tapes 120 may be wrapped around the optical fibers. Each tape 120 may be longitudinally wrapped around the optical fibers 110 and/or any intervening components, such as any internal wraps 130. For example, a tape 120 may be positioned adjacent to the optical fibers 110 (and/or any intervening components). The tape 120 may have two longitudinally extending widthwise edges, and the tape 120 may be curled or otherwise wrapped around the optical fibers 110 (and/or any intervening components) at one or more both widthwise edges. In certain embodiments, the tape 120 may be wrapped until the widthwise edges are brought into contact with one another. In other embodiments, the tape 120 may be wrapped until one widthwise edge overlaps the other widthwise edge. As desired, the tape 120 may be adhered, bonded, fastened or otherwise affixed to itself following the wrapping. Alternatively, one or more suitable binder threads or other suitable components may be utilized to hold the tape 120 in place.

In certain embodiments, the tape 120 may completely encircle or entrap the optical fibers 110 (and/or any intervening components). As desired, any amount of overlap may be formed when the tape 120 is wrapped. For example, a tape 120 may be wrapped such that a relatively small overlap of the tape's edges is formed. As another example, a tape 120 may be wrapped with a substantial overlap, such as an overlap of 25%, 30%, 40%, 50%, 60%, 75%, 80%, 90%, 100%, or greater. In certain embodiments, a tape 120 may be double wrapped, triple wrapped, or wrapped any other suitable amount of time around the optical fibers 110. In this regard, an overall thickness of the tape 120 around the optical fibers 110 may be increased relative to a single wrapping of the tape 120. Additionally, in certain embodiments, a width of the tape 120 may be based at least in part upon a desired overlap to be formed, as well as the dimensions of cable components enclosed by the tape 120.

In other embodiments, one or more low smoke tapes 120 may be helically wrapped around the optical fibers 110. For example, a tape 120 may be wrapped around the optical fibers 110 at an angle along a longitudinal length of the cable 100. A tape 120 may be wrapped at any suitable angle and/or in any suitable direction (e.g., clockwise or counter clockwise). As desired, adjacent wrappings of a tape 120 may overlap one another such that the optical fibers 110 are encircled or entrapped by the tape 120. In other embodiments, any gaps between adjacent wrappings of a first tape may be covered by a second tape. Indeed, any number of suitable tapes may be helically and/or longitudinally wrapped around the optical fibers 110.

A low smoke tape 120 may be formed with a wide variety of suitable constructions and/or from a wide variety of suitable materials. In certain embodiments, a tape 120 may be formed as a woven glass tape. A woven glass tape may be formed from any suitable glass and/or may have any suitable temperature rating. Additionally, the strands woven together to form the tape 120 may have any suitable dimensions, and any suitable number of strands may be utilized. In other embodiments, the tape 120 may be formed as a spun bond glass tape or as a nonwoven glass tape. Any suitable process may be utilized as desired to form a spun bond or nonwoven glass tape. For example, glass fibers and/or other components may be bonded together by chemical, mechanical, or other treatment. Any number of suitable fibers having a wide variety of suitable dimensions may be utilized to form a spun bond or nonwoven glass tape.

In yet other embodiments, the low smoke tape 120 may be formed as a mica tape, silicate tape, or other suitable mineral tape having desirable smoke characteristics. In yet other embodiments, the low smoke tape 120 may be formed as a low smoke zero halogen (“LSZH”) tape. Indeed, the tape 120 may be formed from any suitable material(s) that result in the tape 120 having a relatively low optical smoke density when burned. The material constructions discussed herein are provided by way of non-limiting example only.

Regardless of the material construction, a tape 120 may be formed with any number of suitable layers. In certain embodiments, a tape 120 may be formed from a single layer or as a relatively uniform component. In other embodiments, a tape 120 may include a plurality of layers. Additionally, as desired in various embodiments, a tape 120 may be formed with a wide variety of suitable additives, coatings, and/or backing layers. For example, one or more suitable flame retardant and/or smoke suppressing additives may be integrated into, combined with, and/or otherwise associated with a tape 120. As another example, a flame retardant and/or a smoke suppressing coating may be formed on at least one surface of a tape 120, may at least partially surround the tape 120, and/or may positioned between any two suitable layers of the tape 120. As yet another example, a suitable flame retardant and/or smoke suppressing backing layer may be formed on an interior surface of the tape 120 (i.e., a surface of the tape 120 closest to the optical fibers 110 when the tape 120 is positioned within the buffer tube 105). Examples of other suitable additives, coatings, and/or backing layers include, but are not limited to, water blocking material, water swellable material, strength members, etc.

A tape 120 may also be formed with a wide variety of suitable dimensions. For example, a tape 120 may be formed with any suitable width and/or thickness. In embodiments in which the tape 120 is longitudinally wrapped or curled around the optical fibers 110 (and/or any intervening components), an amount of wrapping may be determined based upon the width of the tape 120. A width of the tape 120 may be based at least in part upon the dimensions of the wrapped components and/or a desired amount of overlap once one or both longitudinally extending widthwise edges of the tape 120 are wrapped. For example, a tape 120 may have a width that permits it to be wrapped around certain components within a buffer tube 105 with a desired amount of overlap. In the event that a tape 120 is helically wrapped around internal components, the tape 120 may have any suitable width that facilitates helical wrapping. Regardless of the way in which a tape 120 is wrapped, in various embodiments, a tape 120 may have a width of approximately 5, 6, 7, 8, 10, 12, 15, 18, 20, 22, 25, 30, 35, 40, 45, 50, or 55 mm, a width incorporated into a range between any two of the above values, or a width incorporated into a range bounded on either a minimum or maximum end by one of the above values.

A tape 120 (and/or various layers of the tape 120) may also be formed with any suitable thickness. For example, a tape may have a thickness of approximately 0.5, 1.0, 1.5, 2.0, 2.5, 3.0, 3.5, 4.0, 4.5, or 5.0 mm, a thickness incorporated into a range between any two of the above values, or a thickness incorporated into a range bounded on either a minimum or maximum end by one of the above values. In certain embodiments, a tape 120 may be wrapped a single time around internal components or, alternatively, a tape 120 may have a relatively small overlap. Accordingly, an amount of tape wrapped around the optical fibers 110 and/or other internal components at any given position may be approximately equal to a thickness of the tape 120. In other embodiments, a tape 120 may be wrapped with a substantial overlap, such as an overlap that results in the tape 120 being wrapped more than once around the optical fibers 110. For example, the tape 120 may be double or triple wrapped around the optical fibers 110. In this regard, an amount of tape wrapped around the optical fibers and/or other internal components may be approximately equal to a combined thickness of the multiple wrappings. As desired, an overall thickness of the tape 120 may be increased by wrapping the tape 120 multiple times. Accordingly, the overall thickness of the tape 120 may be increased by increasing a width of the tape 120.

In certain embodiments, one or more dimensions of a tape 120 may be selected in order to provide a desired burn and/or smoke performance within a cable 100. For example, a thickness and/or width (e.g., for multiple wrappings, etc.) of a tape 120 may be selected in order to provide a desired amount of low smoke and/or flame retardant material between the buffer tube 105 and the optical fibers 110.

Additionally, any suitable number of tapes 120 may be incorporated into a buffer tube 105 as desired in various embodiments. For example, as shown in FIG. 1, a single tape 120 may be utilized. In other embodiments, a plurality of tapes 120 may be longitudinally wrapped around the optical fibers 110. In other embodiments, a plurality of tapes 120 may be helically wrapped around the optical fibers 110. For example, a plurality of tapes 120 may be helically wrapped in opposite directions. As another example, a plurality of tapes 120 may be helically wrapped in the same direction (e.g., clockwise, counterclockwise, etc.). As desired, helically wrapped tapes may be longitudinally offset from one another. Additionally, gaps between adjacent wrappings of a first tape may be covered by the wrappings of a second tape. Indeed, a wide variety of various tape combinations may be incorporated into a cable 100 as desired.

As a result of incorporating one or more low smoke tapes 120 into a buffer tube 105, the cable 100 may exhibit improved burn and/or smoke performance relative to conventional cables. During a burn situation, a first smoke peak typically occurs as an outer jacket of the cable is burned. Following this first smoke peak, the flame or heat may subsequently penetrate a buffer tube within a cable core. In a conventional cable, the flame may then encounter internal components of the buffer tube, such as an optical fiber ribbon. This may provide additional material for burn, thereby increasing the smoke output of the burn event. In many cases, this results in a second smoke peak, thereby preventing a cable from passing average smoke density and/or other burn requirements set forth in cabling standards. However, when one or more low smoke tapes 120 are incorporated into a buffer tube 105, a flame or heat may encounter the tape(s) 120 when the buffer tube 105 is penetrated or compromised. Due to the construction of the tape(s) 120, relatively little smoke may be given off in the burn, thereby eliminating or reducing the effects of a second smoke peak. In certain embodiments, the tape(s) 120 may be formed from one or more materials that melt rather than burn and, therefore, the tape(s) 120 may emit no or very little smoke. Additionally, the tape(s) 120 may limit the ability of or prevent a flame from reaching other components in the buffer tube 105 (e.g., optical fibers 110, etc.).

In a typical burn test performed for a plenum optical fiber cable, such as the tests set forth in NFPA-262 as promulgated by the National Fire Protection Association (“NFPA”) and UL-910 as promulgated by Underwriter Laboratories (“UL”), the cable is placed in a chamber and burned. The cable must have a maximum flame propagation of less than five (5) feet along a longitudinal length of the cable. Additionally, the cable must have a peak optical smoke density of less than or equal to 0.50 during the burn. The cable must also have an average optical smoke density of less than or equal to 0.15 during the burn. As a result of incorporating one or more tape(s) 120 into a buffer tube 105, a cable 100 may satisfy and/or exceed the performance criteria of one or more of these plenum cable tests due to the tape(s) 120 reducing or smoothing smoke output and/or limiting burn effects on cable components entrapped by the tape(s) 120.

Additionally, in certain embodiments, the incorporation of one or more tapes 120 into a buffer tube 105 may have limited or negligible effect on the performance of the optical fibers 110. For example, the tapes 120 may be formed from one or more materials, with suitable dimensions, and/or with suitable wrappings such that the tapes 120 do not negatively affect attenuation and/or other performance of the optical fibers 110. In certain embodiments, the tapes 120 may be incorporated into a buffer tube 105 in a manner that does not materially contribute to increased microbending of the optical fibers 110.

With continued reference to FIG. 1, in certain embodiments, one or more additional layers and/or components 130 may be incorporated into the buffer tube 105. For example, one or more strength members (e.g., aramid yarns, etc.) and/or water blocking materials may be incorporated into the buffer tube 105. In certain embodiments, an additional layer (e.g., strength layer, water blocking layer, etc.) may be positioned between the low smoke tape(s) 120 and the optical fibers 110.

A wide variety of suitable strength members may be incorporated into the buffer tube 105 as desired in various embodiments. Examples of suitable strength members include strength yarns (e.g., aramid yarns, fiberglass yarns, etc.), strength fibers (e.g., aramid fibers, Spectra® fiber, Technora® fiber, basalt fiber, etc.), ultra-high-molecular weight polyethylene, etc. Any number of strength members may be incorporated into a buffer tube 105 as desired. Additionally, in various embodiments, strength members may be loosely positioned within a buffer tube 105, helically twisted or otherwise wrapped around the optical fibers 110, and/or incorporated into one or more layers that surround the optical fibers 110.

In certain embodiments, a suitable filling compound may be utilized to fill a buffer tube 105. In other words, a filling compound may be utilized to fill the interstitial spaces within the buffer tube 105 that are not occupied by optical fibers 110 (or other components). A wide variety of filling compounds may be utilized as desired. For example, a water-blocking gel, such as Polymer Fiber Matrix (“PFM”) gel manufactured and marketed by Superior Essex International LP, may be utilized as a filling compound. The PFM gel may be a non-sticky, water-blocking material that reduces friction between the buffer tube and the optical fibers 110 while permitting easy cleaning of the optical fibers 110 during installation. Other suitable filling compounds, such as water-blocking gels, grease, foam materials, etc. may be utilized as desired. In other embodiments, the cable 100 may be formed as a “dry” cable that does not include a filling compound. As desired, water-blocking tapes, water-blocking wraps, water-blocking yarns, water-blocking powders, moisture absorbing materials, and/or a wide variety of other suitable materials may be incorporated into the buffer tube 105. A dry water-blocking component may include any number of suitable water-blocking materials, such as super absorbent polymers (“SAP”) and/or other suitable materials. Additionally, a “dry” cable component may be formed as a relatively continuous layer that is incorporated into the buffer tube 105. For example, a “dry” cable component may be wrapped around, enclose, or entrap certain optical fibers 110. In other embodiments, a “dry” cable component may include a plurality of discrete components that are intermittently wrapped, partially wrapped, or otherwise positioned within the buffer tube 105 at any number of desired locations (e.g., a plurality of spaced locations, in a relatively continuous manner, etc.) along a longitudinal length of the cable 100.

In certain embodiments, one or more additional layers and/or components 135 may be positioned outside or around the buffer tube 105. For example, one or more strength members (e.g., aramid yarns, etc.) and/or water blocking materials may be positioned between the buffer tube 105 and the jacket 125. A wide variety of suitable strength members may be positioned outside the buffer tube 105 as desired in various embodiments. Examples of suitable strength members include strength yarns (e.g., aramid yarns, fiberglass yarns, etc.), strength fibers (e.g., aramid fibers, Spectra® fiber, Technora® fiber, basalt fiber, etc.), ultra-high-molecular weight polyethylene, etc. Any number of strength members may be incorporated into the cable 100 as desired. Additionally, in various embodiments, strength members may be loosely positioned within a cable core, helically twisted or otherwise wrapped around the buffer tube 105, and/or incorporated into one or more layers that surround the buffer tube 105.

In certain embodiments, one or more water-blocking components may additionally or alternatively be positioned outside of the buffer tube 105. For example, one or more water-blocking threads may be wrapped around the buffer tube 105 or positioned adjacent to the buffer tube 105 within the cable 100. As another example, a water-blocking tape may be wrapped around the buffer tube 105. Indeed, a water-blocking component may be formed with a wide variety of suitable constructions (e.g., yarns, tapes, etc.). Additionally, a water-blocking component may include any number of suitable water-blocking materials, such as super absorbent polymers (“SAP”) and/or other suitable materials. Additionally, a water-blocking component may be formed as a relatively continuous layer that is incorporated into the cable 100. For example, a water-blocking component may be a continuous component that is wrapped around or positioned adjacent to the buffer tube 105. In other embodiments, a water-blocking component may include a plurality of discrete components that are intermittently wrapped, partially wrapped, or otherwise positioned about the buffer tube 105 at any number of desired locations (e.g., a plurality of spaced locations, in a relatively continuous manner, etc.) along a longitudinal length of the cable 100.

FIG. 2 is a cross-sectional view of another example cable 200 that incorporates one or more low smoke tapes, according to an illustrative embodiment of the disclosure. The cable 200 of FIG. 2 may include certain components that are similar to the cable 100 of FIG. 1; however, the cable 200 of FIG. 2 may include a plurality of fiber optic buffer tubes rather than a single buffer tube. As shown, a plurality of buffer tubes 205A-F may be situated around a central strength member (“CSM”) 210. A jacket 215 may then be formed around the buffer tubes 205A-F and the central strength member 210. Although six buffer tubes 205A-F are illustrated, any number of buffer tubes can be utilized. In other embodiments, the buffer tubes 205A-F may be situated around a central tube, a central group of twisted pairs, a central ribbon assembly, or other central cable component(s)). Additionally, although a single ring or layer of buffer tubes 205A-F is illustrated, in other embodiments, multiple rings or concentric layers of buffer tubes may be utilized. As desired, one or more of the buffer tubes 205A-F may be replaced with other components, such as strength members or spacers. Indeed, a wide variety of suitable buffer tube arrangements may be utilized.

Each of the buffer tubes 205A-F may be situated within a cable core. The buffer tubes 205A-F may be loosely positioned within the core or, alternatively, stranded or twisted together or around the CSM 210. Each of the buffer tubes 205A-F may include similar components as the buffer tube 105 discussed above with reference to FIG. 1. For example, each buffer tube (generally referred to as buffer tube 205) may include one or more optical fibers, such as optical fibers incorporated into one or more ribbons or a ribbon stack. Additionally, one or more low smoke tapes 220 may be wrapped or positioned around the optical fibers. As desired, one or more additional layers and/or components (e.g., water blocking components, strength members, etc.) may optionally be positioned between the optical fibers and the tape(s) 220. During a burn event, the tape(s) 220 may provide improved burn and/or smoke performance in a similar manner as that discussed above with reference to FIG. 1.

The CSM 210 may provide strength and structural support for the cable 200 and the other components of the cable 200. For example, the CSM 210 may provide desired tensile and/or compressive strength that supports the axial load of cable 200 and assists in preventing or limiting attenuation within the optical fibers. The CSM 210 may be formed from a wide variety of suitable materials and/or combinations of materials. According to an aspect of the disclosure, the CSM 210 may include or be formed with a plurality of different strength layers. For example, the CSM 210 may be formed from a metallic rod, glass reinforced plastic (“GRP”), fiber reinforced plastic (“FRP”), fiberglass, fiberglass/epoxy composite, strength yarns (e.g., helically twisted strength yarns, etc.) and/or other suitable materials. In certain embodiments, the CSM 210 may include a plurality of different layers, such as a relatively rigid layer (e.g., GRP, etc.) and a relatively flexible layer (e.g., strength yarns, etc.). Indeed, a CSM 210 may be formed with a wide variety of suitable constructions. As desired, a CSM 210 may also include a polymeric or other suitable coating.

With continued reference to FIG. 2, one or more layers or components may be wrapped around the plurality of buffer tubes 205A-F and the CSM 210 and/or positioned within the cable core adjacent to the buffer tubes 205A-F. For example, one or more water blocking layers 225 (e.g., a water blocking tape, etc.) may be wrapped around the buffer tubes 205A-F and the CSM 210 and/or positioned adjacent to the buffer tubes 205A-F within the cable core (e.g., loosely positioned within the cable core, etc.). As another example, one or more strength layers (e.g., aramid yarns, etc.) 230 may be wrapped around the buffer tubes 205A-F and/or otherwise positioned with a cable core (e.g., positioned adjacent to one or more buffer tubes 205A-F, etc.). These layers may be similar to those discussed above with reference to FIG. 1.

The cables 100, 200 illustrated in FIGS. 1 and 2 are provided by way of example only to illustrate a few cable constructions that may incorporate one or more low smoke tapes into buffer tubes and/or optical fiber assemblies. A wide variety of other components may be incorporated into a cable as desired in other embodiments. For example, a cable may include an internal wrap or jacket, a binding layer, a wide variety of suitable transmission media, a wide variety of different types of tubes, spacers, strength members, water blocking materials, water swellable materials, insulating materials, dielectric materials, flame retardants, flame suppressants or extinguishants, gels, fillers, and/or other materials. Additionally, a cable may be designed to satisfy any number of applicable cable standards. These standards may include various operating environment requirements (e.g., temperature requirements), signal performance requirements, burn testing requirements, etc.

Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

Although specific embodiments have been described above in detail, the description is merely for purposes of illustration. It should be appreciated, therefore, that many aspects described above are not intended as required or essential elements unless explicitly stated otherwise. Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

1. A fiber optic cable comprising:
an outer jacket defining a cable core;
a buffer tube positioned within the cable core;
one or more optical fibers positioned within the buffer tube; and
a tape wrapped around and encircling the one or more optical fibers along a longitudinal direction within the buffer tube, wherein the tape contacts an inner surface of the buffer tube, comprises one of woven glass or spun bond glass, and has an average optical smoke density equal to or below 0.15 when burned.

2. (canceled)

3. (canceled)

4. (canceled)

5. The fiber optic cable of claim 1, wherein the tape comprises a plurality of tapes.

6. The fiber optic cable of claim 1, wherein the tape is longitudinally wrapped around the one or more optical fibers.

7. The fiber optic cable of claim 1, wherein the tape is helically wrapped around the one or more optical fibers.

8. The fiber optic cable of claim 1, wherein the cable has an average optical smoke density below 0.15 and a peak optical smoke density below 0.50 when subjected to a twenty minute plenum burn test.

9. The fiber optic cable of claim 1, wherein the tape comprises a flame retardant coating.

10. The fiber optic cable of claim 1, wherein the tape comprises at least one of a flame retardant additive or a smoke suppressant additive.

11. The fiber optic cable of claim 1, wherein the one or more optical fibers comprise a plurality of optical fibers incorporated into one or more fiber optic ribbons.

12. The fiber optic cable of claim 1, further comprising:
at least one of (i) a strength layer or (ii) a water blocking layer positioned between the tape and the one or more optical fibers.

13. The fiber optic cable of claim 1, further comprising:
at least one of (i) a strength layer or (ii) a water blocking layer positioned between the outer jacket and the buffer tube.

14. A fiber optic cable comprising:
at least one buffer tube;
one or more optical fibers positioned within the buffer tube; and
a tape wrapped around and encircling the one or more optical fibers along a longitudinal direction within the buffer tube, wherein the tape contacts an inner surface of the buffer tube, comprises one of woven glass or spun bond glass, and has an average optical smoke density equal to or below 0.15 when burned.

15. (canceled)

16. (canceled)

17. (canceled)

18. The fiber optic cable of claim 14, wherein the tape comprises a plurality of tapes.

19. The fiber optic cable of claim 14, wherein the tape is longitudinally wrapped around the one or more optical fibers.

20. The fiber optic cable of claim 14, wherein the tape is helically wrapped around the one or more optical fibers.

21. The fiber optic cable of claim 14, wherein the cable has an average optical smoke density below 0.15 and a peak optical smoke density below 0.50 when subjected to a twenty minute plenum burn test.

22. The fiber optic cable of claim 14, wherein the tape comprises a flame retardant coating.
